(19) United States
(12) Patent Application Publication
(10) Pub. No.: US 2026/0278207 A1
(43) Pub. Date: Sep. 17, 2026

(54) CONCURRENT FRAMEWORK FOR MULTI-PHYSICS TOPOLOGY OPTIMIZATION WITH DESIGN AND MANUFACTURING CONSTRAINTS

(71) Applicant: Siemens Corporation, Washington, DC (US)

(72) Inventors: Heng Chi, Princeton, NJ (US); Lucia Mirabella, Princeton, NJ (US); Tsz Ling Elaine Tang, Princeton, NJ (US); Yu-Chin Chan, Princeton, NJ (US); Robin Bornoff, Newbury (GB)

(73) Assignee: Siemens Corporation, Washington, DC (US)

(21) Appl. No.: 19/164,343

(22) PCT Filed: Mar. 24, 2023
(86) PCT No.: PCT/US2023/016243

§ 371 Date: Sep. 11, 2025

(51) Int. Cl. G06F 30/23; G06F 111/06

(52) U.S. Cl. CPC G06F 30/23; G06F 2111/06

(57) ABSTRACT

A system includes two or more physics solvers to generate one or more physical field variables, and one or more objective values based on received design variables. Two or more sensitivity computational modules compute a sensitivity field based on the mesh and the physical field variables. A design optimizer module (240) generates an updated design comprising one or more new design variables by executing an optimization of the design domain based on the sensitivity field, the objective values, one or more optimization requirements, one or more design constraints, and one or more manufacturing constraints. An iterative topology optimization is performed by iterations of the design optimizer sending updated design variables to the two or more physics solvers and sensitivity computational modules and receiving new sensitivity fields from the two or more sensitivity modules based on the updated design variables.

### TECHNICAL FIELD

The present disclosure is directed, in general, to a topology optimization framework that is capable of concurrent accounting for multi-physics sensitivities, design and manufacturing constraints. The technology described herein is particularly well-suited for, but not limited to, additive manufacturing and other similar fabrication methods.

### BACKGROUND

Topology optimization has gained popularity recently in generating new designs, given its flexibility in generating freeform designs, which can potentially offer superior product performance and cost reduction. The advancement in additive manufacturing technology has also enabled the production of very complex shapes. Currently, most topology optimization solvers used for design often involve a single type of physics (structural analysis is the most common type), and also only involve simplified loads and boundary conditions (i.e., these conditions are not expected to change with the design). However, for the performance of a lot of products, other types of physics are often involved, such as heat transfer, fluid flow and structural performance. Multi-physics topology optimization considers multiple physics phenomena during the design procedure, requiring the solutions of multiple physics equations at each optimization step. Among multi-physics topology optimization, structural-fluid topology optimization is a popular domain which requires the solutions of both structural and fluid problems. In aerodynamic components, the structure is often surrounded by a fluid that also exerts both structural (e.g., pressure load) and thermal loads (e.g., heat flux) to the structure. Such a design needs to be able to account for the product's thermal performance (e.g., minimum thermal load, maximum allowable temperature constraint) in addition to mechanical performance requirements.

Conventional multi-physics topology optimizations are done in a sequential manner. The optimization trajectory of the design in such a sequential approach makes topology optimization susceptible to local minima, especially when the two or more physics have competing contributions to the objective or constraint functions, making sequential design update inefficient and significantly favoring the optimization related to the last solver in the chain. Moreover, the incorporation of manufacturing constraints (e.g. for additive manufacturing (AM)) into the topology optimization, which is essential to enable its industrial applications, has yet to be achieved.

To illustrate an example of sequential topology optimization, consider a structural-fluid topology optimization. A first physics topology (e.g., fluid) optimization is first conducted to optimize the design considering the mechanics of the first physics. The optimized parameters of the first physics (e.g., identified fluid flow/duct geometric faces) are then considered fixed when a second physics optimization is conducted (e.g., structural topology). Finally, a design step for AM is performed outside of the optimizations that then locally modifies the geometry, disregarding and superseding the previously optimized geometry. This sequential approach has disadvantages, such as being susceptible to bad local minima and suboptimal solutions because the requirements coming from the different physics may be competing. Furthermore, the overall sequential workflow is highly inefficient both from the algorithm and implementation perspectives as one has to setup and conduct multiple single-physics topology optimization runs, which are each quite time consuming.

### SUMMARY

Aspects of the disclosure include a system having two or more physics solvers to generate one or more physical field variables, and one or more objective values based on received design variables. Two or more sensitivity computational modules compute a sensitivity field based on the mesh and the physical field variables. A design optimizer module generates an updated design comprising one or more new design variables by executing an optimization of the design domain based on the sensitivity field, the objective values, one or more optimization requirements, one or more design constraints, and one or more manufacturing constraints. An iterative topology optimization is performed by iterations of the design optimizer sending updated design variables to the two or more physics solvers and sensitivity computational modules and receiving new sensitivity fields from the two or more sensitivity modules based on the updated design variables.

### BRIEF DESCRIPTION OF THE DRAWINGS

The foregoing and other aspects of the present disclosure are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 provides an example topology optimization framework that is able to account for multi-physics load and boundary conditions in accordance with embodiments of this disclosure.

FIG. 2 illustrates an example variant of the framework shown in FIG. 1 based on a dual physics topology optimization in accordance with embodiments of this disclosure.

FIG. 3 illustrates an example of coordinating multi-discretization of computation grids for the multi-physics topology optimization in accordance with embodiments of this disclosure.

FIG. 4 illustrates an example of design variable mapping between computational grids in accordance with embodiments of this disclosure.

FIG. 5 provides an example of a parallel processing memory architecture that may be utilized to perform computations related to topology optimization, according to embodiments of the present disclosure.

### DETAILED DESCRIPTION

Systems and methods are described herein which relate generally to a framework for multi-physics topology optimization that concurrently optimizes competing physics as well as design and manufacturing constraints. This framework is designed as a “plug-n-play” system that can be readily configured with different multi-physics-based models to solve a variety of design problems. Thus, for example, the framework discussed herein may be used to perform topology optimization using any combination of physics models (e.g., structural-thermal, structural-flow, thermal-flow) that could have different mesh types. Moreover, the framework can be readily adapted to incorporate additional physics models (acoustics, electromagnetics, etc.) as needed to support design development.

The topology optimization framework disclosed herein provides various benefits over conventional solutions. For example, topology optimization is completely concurrent. Unlike existing frameworks where different physics and manufacturing constraints are incorporated sequentially, the the proposed topology optimization framework disclosed herein accounts all the physics and manufacturability simultaneously within a single optimization loop. While existing multi-physics topology optimization framework only adopt one computational grid and one type of design representation (e.g., either density-based for structural physics or level-set for fluid physics), the proposed framework allows for adoption of multiple design representations for multiple physics within a single topology optimization framework. Moreover, the proposed framework allows for different solvers for different physics, which is not possible in existing frameworks. The concurrent optimization framework is a viable replacement for the otherwise inefficient and manual sequential approach by a unified and single workflow. In addition, it allows for the balance of competing multi-physics requirements so as to enable the creation of a Pareto front of designs in a way that the existing sequential approach cannot. Furthermore, the proposed framework is extendable to include more than two physics solvers and respective sensitivity computational grids, enabling designing for more complex problems.

The topology optimization framework of this disclosure leverages a multi-discretization approach. The simulations of multiple physics phenomena can be performed on different discretizations/meshes, using different simulators, and with different design representations. Manufacturing constraints (e.g., manufacturability via additive manufacturing) and design constraints (e.g., solid volume) are naturally incorporated even with different representation of the design for different physics phenomena. The concurrent topology optimization framework is general and is readily extendable to include any types and number of physics solvers and respective sensitivity computational grids simultaneously in a single design iteration, enabling design capability to solve topology problems of greater complexity than by conventional solvers.

Topology optimization typically determines the distribution of two material states/types (e.g., distribution of solid and void within a domain) within the defined design space. The topology optimization solver assumes a design variable of material definition that ranges from 0 to 1 (later referred as density factor). For different physics applications, this factor may have different definitions. Additionally, it can be used in the optimization algorithm to modify the design based on the computed sensitivity. For instance, in structural topology optimization, when the density factor value is 1, it means that particular region is solid (having material density and property of solid). If it is 0, it means that that region is void (having material density close to zero). Typical material properties include Young's modulus and thermal conductivity. For other problems, different material properties may be defined as a function of the design variable. For example, in conjugate heat transfer, design variable of 1 refers to solid material properties and design variable of 0 denotes fluid material properties. For the intermediate density factor values, the relationship between density factor and material properties will be interpolated by a material interpolation scheme chosen by the user (e.g., Solid Isotropic Material with Penalization, Rational Approximation of Material Properties). One typical objective of structural topology optimization problems is to minimize compliance, but this framework can also apply to other types of objectives, and also multiple numbers of objectives and constraints. This approach can be applied to 2D or 3D topology optimization that can handle requirements of different types of physics (e.g., structural, fluid, and thermal).

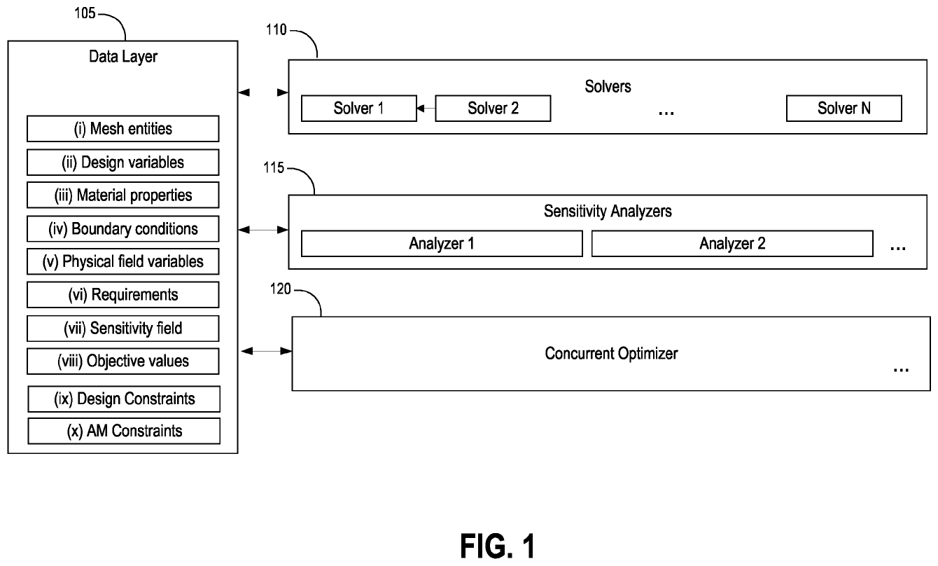

FIG. 1 provides an example of a topology optimization framework that is able to account for multi-physics load and boundary conditions, according to some embodiments. The framework includes a plurality of software modules organized as a Data Layer 105, Solvers 110, Sensitivity Computation of Physics Modules 115, and Optimizers 120. The term “module,” as used herein, refers to a software component that performs one or more functions. Each module may be a discrete unit, or the functionality of multiple modules can be combined into one or more units that form part of large program. In the example of FIG. 1, the Data Layer 105, Solvers 110, Objective and Sensitivity Analyzer Modules 115, and Concurrent Optimizer 120 are organized to form the program for performing topology optimization.

The Data Layer 105 handles analysis data used in performing topology optimization. In the example of FIG. 1, different types of analysis data are shown, including: mesh entities (i.e., node sets, element sets, etc.), design variables, material properties, boundary conditions, physical field variables, requirements; sensitivity field data, and objective values for optimizations.

The Data Layer 105 is where topology optimization is triggered and iterated. The Data Layer 105 serves as the backbone to communicate with different analysis components (i.e., Solvers 110, Sensitivity Analyzers 115, and Optimizer 120). For example, in some embodiments, the Data Layer 105 includes one or more application programming interfaces (APIs) that allow analysis components to access and update the analysis data. In network-based architectures, a Representational State Transfer (REST) design may be used to access and manipulate the analysis data at the Data Layer 105.

In some embodiments, the Data Layer 105 also includes utilities to automate operations on the mesh, boundary conditions, and analysis data. For example, when automatically detecting mesh regions, the design variable for the topology optimization domain can range from 0 to 1.

The Solvers 110 include one or more physics solvers. Each solver obtains input data from the Data Layer 105, performs physics analysis (e.g., finite element analysis for structural, heat transfer, etc.), and provides the outputs of the analysis to the Data Layer 105.

The Sensitivity Analyzers 115 use one or more plug-ins to compute sensitivity of physics variables with respect to design variables. For different physics and objectives, different sensitivity computation modules may be used.

The Concurrent Optimizer 120 uses objective values, sensitivity fields, constraint values (such as design volume and AM constraint values), and the current design variables stored at the Data Layer 105, to compute updated design variable fields.

The framework shown in FIG. 1 is modular and flexible. It has componentized architecture to allow different solvers, and different objective/cost functions to be included in the workflow. Different solvers and sensitivity computation plug-ins can be used and coupled with the data layer to perform topology optimization based on the problem type.

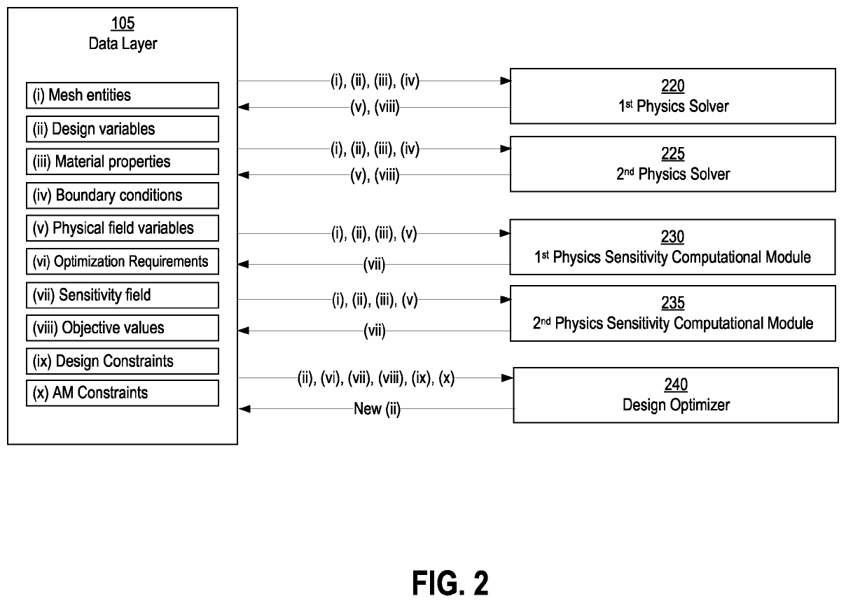

FIG. 2 illustrates an example variant of the framework shown in FIG. 1 based on a dual physics topology optimization in accordance with embodiments of this disclosure. In this example, a first physics solver 220 (e.g., structural physics) and a second physics solver 225 (e.g., fluid physics) generate physical field variables and objective values based on mesh entities, design variables, material properties, boundary conditions received from data layer 105. A first physics sensitivity computational module 230 (e.g., structural physics) and a second physics sensitivity computational module 235 (e.g., fluid physics) generate sensitivity fields based on mesh entities, design variables, material properties, and physical field variables received from data layer 105. Design optimizer 240 generates updates to the design variables based on optimization requirements, sensitivity fields, objective values, design constraints (e.g., design volume), and AM constraints received from data layer 105.

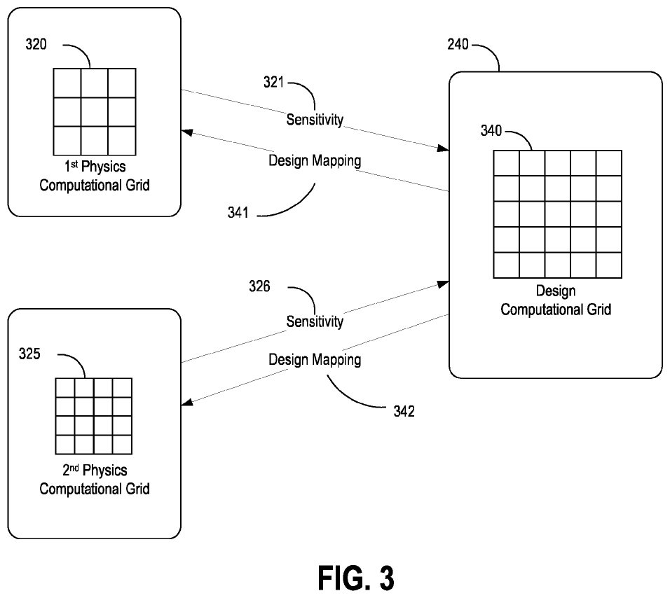

FIG. 3 illustrates an example of coordinating multi-discretization of computation grids for the multi-physics topology optimization in accordance with embodiments of this disclosure. In an embodiment, computations by first physics solver 220 and first physics sensitivity analyzer 230 are performed on first physics computation grid 320. Computations by second physics solver 225 and second physics sensitivity analyzer 235 are performed on second physics computation grid 325. Concurrent optimizer 240 defines design variables according to design optimizer computation grid 340. Each of the three computation grids 320, 325 and 340 may have different discretizations as shown in FIG. 3. In this example, the topology optimization problem can be defined for additive manufacturing with the first physics relating to structural design constraints and the second physics relating to fluid design constraints, represented according to the following expressions:

$${min}_{z} \{ {J}_{s} ( z ) + {J}_{f} ( z ) \}$$

$$s . t . {g}_{vol} ( z ) \leq 0$$

$${g}_{AM} ( z ) \leq 0$$

$$with K ( z ) u = F ( structural equation )$$

$$R ( z , v , ρ ) = 0 ( fluid equation )$$

where: z is the design variable vector,
Jₛ and J_{f} are the objective functions associated with the structural and fluid performance, respectively,
gᵥₒₗ(z) is the constraint on total solid volume of the design,
g_{AM}(z) are the AM constraints which ensures the constructability of the design using AM techniques,
F is the mechanical force applied on the design,
u is the displacement solution of the structural equation, and
v and p are the velocity and pressure solutions to the fluid equation.

At each iteration of the topology optimization, both structural and fluid performance and sensitivity of the design needs to be evaluated by structural and fluid equations, the latter of which could be either linear (i.e., Stokes equation) or nonlinear (i.e., Navier-Stokes equations).

An objective of the framework as shown in FIG. 3 is to adopt a multi-discretization approach with the three computation grids. The design variables are transformed to geometry variables that define the total volume of the solid design using the design optimizer computation grid 340, which also evaluates manufacturing constraints as most AM constraints are geometry based. Forward and adjoint structural solvers operate on computation grid 320 to determine structural performance, structural objective, and structural constraint sensitivity for the design. Forward and adjoint fluid solvers operate on computation grid 325 to determine fluid performance, fluid objective, and fluid constraint sensitivity for the design. The information synchronization between the three computational grids is enabled by consistent design mappings enforced on the design optimizer computation grid 340 which is described below. As shown in FIG. 3, the structural computation grid 320 and the fluid computation grid 325 are completely independent to each other. Therefore, one can flexibly choose different meshes and simulation methods to perform the structural and fluid problems with different software. For example, the finite element method (FEM) can be used to perform the structural analysis on computation grid 320 while the finite volume method (FVM) can be used for flow analysis on computation grid 325. This independence is an advantage of the proposed framework with respect to a single computational grid approach applied in conventional topology optimization frameworks.

A key challenge in performing topology optimization on separate computational grids is how to synchronize information among various computational grids and perform collective design updates incorporating sensitivity information from all the computational grid concurrently. To overcome this challenge, design optimizer 240 applies a design mapping scheme on computation grid 340 and distributes a specialized design mapping 341 to structural solver 220 and specialized design mapping 342 to fluid solver 225.

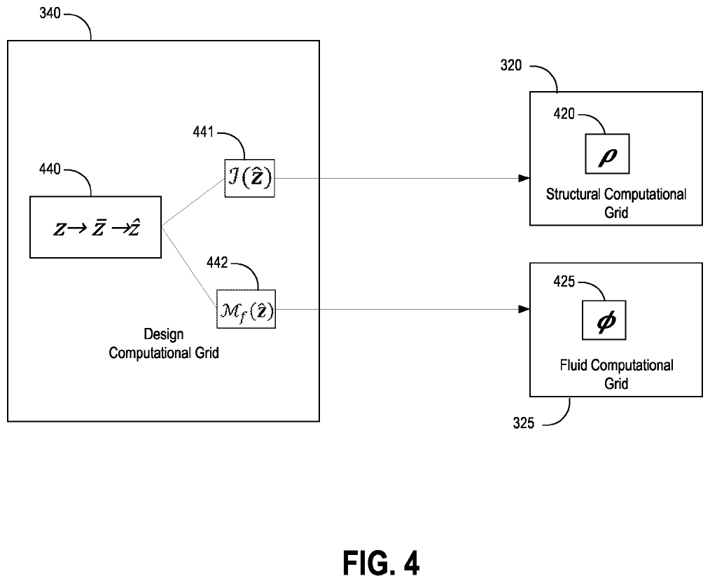

FIG. 4 illustrates an example of design variable mapping between computational grids in accordance with embodiments of this disclosure. Mapping operation 441 is performed on the design computational grid 340 to map design variables to structural representation variables 420. Concurrent to mapping operation 441, mapping operation 442 is performed on design computational grid 340 to map design variables to fluid representation variables 425. Design variables are first preprocessed using operator 440 to ensure that topology optimization formulation is well-posed. Initial design variable vector z is defined on the design computational grid 340. Element e in the design computational grid 340 is associated with a design variable Ze, which is the eth component of the design variable vector z. The design variables z are first filtered using a convolution operator [symbol] (·), yielding an intermediate design variable Z which is defined by the following expression:

$${\overline{z}}_{i} = \frac{{\sum }_{e ∈ {N}_{i , e}} {z}_{e} ( R - ‖ {x}_{e} - {x}_{i} ‖ )}{{\sum }_{e ∈ {N}_{i , e}} ( R - ‖ {x}_{e} - {x}_{i} ‖ )} \to \overline{z} = ℱ ( z )$$

where N_{i,e} is the set of indices of the neighboring elements with centroids xₑ are of within radius R to the centroid xᵢ of element i, and R is a user-defined radius for the filter operation.

After obtaining the intermediate filtered variable vector z̅, a smoothed Heaviside projection operator [symbol] (·) is applied in operator 440 of the design computational grid 340 for projecting to geometry variable vector \hat{z}. The Heaviside projection is defined as according to the following expression:

$$\hat{z} = ℋ ( \overline{z} , β , η ) = \frac{tanh ( βη ) + tanh ( β ( \overline{z} - η ) )}{tanh ( βη ) + tanh ( β ( 1 - η ) )}$$

where η is the threshold value and β is the steepness of the projection operator. The use of Heaviside projection helps to promote 0-1 designs with crispy interface between the void and solid phases. The geometry variable vector \hat{z} describes the geometry of the design which is used to compute the volume of the design as well as to evaluate the AM constraints.

Since the structural computational grid 320 is independent from the design computational grid 340, mapping of the geometry vector \hat{z} is then performed by operator 441 to map from the design computational grid 340 to the structural computational grid 320. In this illustrative example, the structural computational grid 320 utilizes a density-based approach for topology optimization. As such, structural design representation 420 is defined as density vector ρ of structural computational grid 320 and is obtained by mapping operator 441 which applies an interpolation function [symbol] (·) to the geometry variable vector \hat{z} to give ρ= [symbol] (\hat{z}). The specific choice of interpolation function [symbol] (·) can be nearest neighbor interpolation, linear interpolation, or higher-order interpolation, depending on the difference of resolutions between the geometry and structural grids. Once the density vector ρ is obtained on the structural grid, one can then follow the standard procedure in density-based structural topology optimization to apply material interpolation (such as the SIMP rule) to obtain the distribution of properties (i.e., Young's modulus) of the design.

The mapping from the design computational grid 340 to the fluid computational grid 325 follows a similar procedure to the one described above for the structural computational grid 320. In an embodiment, for fluid design representation 425, the fluid computational grid 325 may utilize the level set approach for topology optimization. Thus, the fluid design representation 425 is defined as level set representation φ on the fluid computational grid 325. Mapping operator 442 applies mapping function [symbol] _{f}(·) to the geometry variable vector \hat{z} according to the following expression:

$$ϕ = {ℳ}_{f} ( \hat{z} ) = {ϕ}_{min} + ( {ϕ}_{max} - {ϕ}_{min} ) 𝒥 ( \hat{z} )$$

where the geometry variable vector \hat{z} is interpolated to the fluid computational grid 325 via the interpolation operator [symbol] (·), and then scaled to the corresponding interval [φₘᵢₙ, φₘₐₓ] of the level set field.

Returning to FIG. 3, since design variables z are defined on the design computational grid 340, the sensitivity information 321, 326 is to be mapped from both structural computational grid 320 and fluid computational grid 325 back to the design computational grid 340 so that the design update is performed in a synchronized and concurrent manner. The following consistent approach is applied to pass the sensitivity information 321, 326. Assume that object functions Jₛ(ρ) and J_{f}(φ) have been computed on structural computational grid 320 and fluid computational grid 325, respectively. Using the adjoint method, the sensitivity information of ∂Jₛ/∂ρ and ∂J_{f}/∂φ may then be computed on structural computational grid 320 and fluid computational grid 325, respectively. The next steps are to collect and map the sensitivity information 321, 326 back to the design computational grid 340 concurrently.

More specifically, the sensitivity 321 of the structural objective function Jₛ is computed with respect to the design variables using chain rule as follows:

$$\frac{\partial {J}_{s}}{\partial z} = \{ \frac{\partial \overline{z}}{\partial z} \cdot [ \frac{\partial \hat{z}}{\partial \overline{z}} \cdot ( \frac{\partial ρ}{\partial \hat{z}} \cdot \frac{\partial {J}_{s}}{\partial ρ} ) ] \} = \{ \frac{\partial ℱ ( z )}{\partial z} \cdot [ \frac{\partial ℋ ( \overline{z} )}{\partial \overline{z}} \cdot ( \frac{\partial 𝒥 ( \hat{z} )}{\partial \hat{z}} \cdot \frac{\partial {J}_{s}}{\partial ρ} ) ] \}$$

Similarly, the sensitivity of the fluid objective function J_{f} with respect to the design variables are obtained using chain rule as follows:

$$\frac{\partial {J}_{f}}{\partial z} = \{ \frac{\partial \overline{z}}{\partial z} \cdot [ \frac{\partial \hat{z}}{\partial \overline{z}} \cdot ( \frac{\partial ϕ}{\partial \hat{z}} \cdot \frac{\partial {J}_{f}}{\partial ϕ} ) ] \} = \{ \frac{\partial ℱ ( z )}{\partial z} \cdot [ \frac{\partial ℋ ( \overline{z} )}{\partial \overline{z}} \cdot ( \frac{\partial {ℳ}_{f} ( \hat{z} )}{\partial \hat{z}} \cdot \frac{\partial {J}_{f}}{\partial ϕ} ) ] \}$$

Since the mapping from the design computational grid to both structural and fluid computational grids are continuous and differentiable, the above sensitivities can be computed analytically and exactly. Once both are computed, the sensitivity of the objective function with respect to the design variables z according to the following combination:

$$\frac{\partial J}{\partial z} = \frac{\partial {J}_{s}}{\partial z} + \frac{\partial {J}_{f}}{\partial z}$$

which collects both sensitivity information for the structural and flow performance. In an embodiment, this combination may be weighted by an algorithm to control trade-off and balancing for the topology optimization of the design toward one of the multi-physics in the solution (e.g., favoring structural considerations over fluid considerations).

With respect to factoring AM constraints into the topology optimization framework, a manufactured object may be designed with a geometry having a freeform with organic surface topology which needs to be evaluated for manufacturability within the design loop. To achieve this, manufacturability constraints are defined (e.g., ensuring the design does not contain small geometric features that is not printable by the machine printing resolution and the overhang angle of the entire object surface does not violate the limit required by the selected AM process). Similarly, volume constraints are defined to ensure that the design does not exceed certain limits (e.g., material cost factors). Because the volume constraints gᵥₒₗ(z) and AM constraints g_{AM}(z) are defined on the geometry grid directly, their sensitivity can be computed as follows:

$$\frac{\partial {g}_{vol}}{\partial z} = \frac{\partial \overline{z}}{\partial z} \cdot ( \frac{\partial \hat{z}}{\partial \overline{z}} \cdot \frac{\partial {g}_{vol}}{\partial \hat{z}} ) = \frac{\partial ℱ ( z )}{\partial z} \cdot ( \frac{\partial ℋ ( \overline{z} )}{\partial \overline{z}} \cdot \frac{\partial {g}_{vol}}{\partial \hat{z}} )$$

$$\frac{\partial {g}_{AM}}{\partial z} = \frac{\partial \overline{z}}{\partial z} \cdot ( \frac{\partial \hat{z}}{\partial \overline{z}} \cdot \frac{\partial {g}_{AM}}{\partial \hat{z}} ) = \frac{\partial ℱ ( z )}{\partial z} \cdot ( \frac{\partial ℋ ( \overline{z} )}{\partial \overline{z}} \cdot \frac{\partial {g}_{AM}}{\partial \hat{z}} )$$

Once all the sensitivity information of the objective and constraint functions is collected onto the design computation grid, any design update scheme (e.g., method of moving asymptotes) can be used to update the design variables to obtain the design in the next topology optimization iteration.

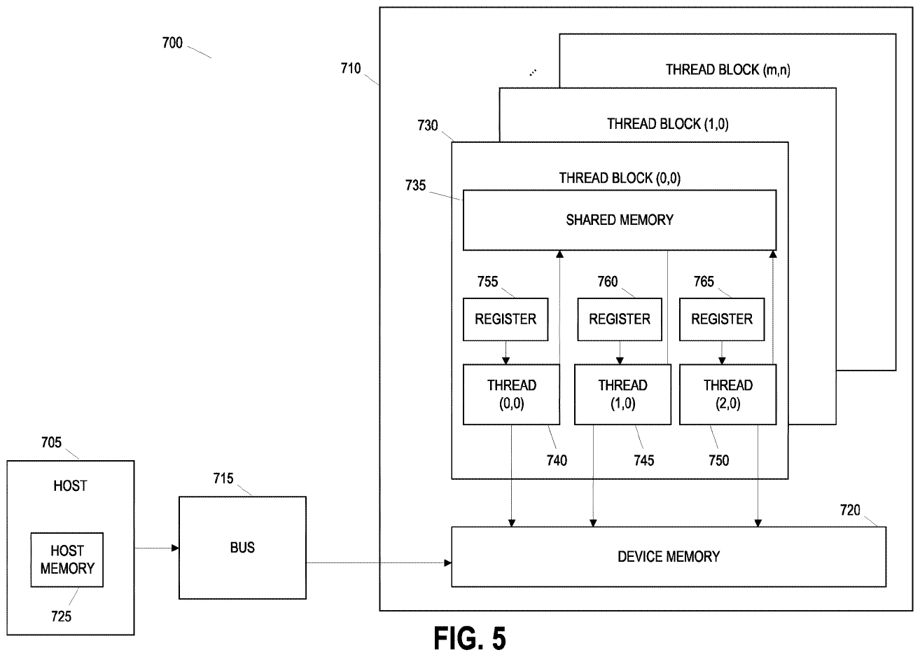

FIG. 5 provides an example of a parallel processing memory architecture 700 that may be utilized to perform computations related to topology optimization, according to some embodiments of the present invention. This architecture 700 may be used in embodiments of the present invention where NVIDIA™ CUDA (or a similar parallel computing platform) is used. The architecture includes a host computing unit (“host”) 705 and a GPU device (“device”) 710 connected via a bus 715 (e.g., a PCIe bus). The host 705 includes the central processing unit, or “CPU” (not shown in FIG. 5) and host memory 725 which is accessible to the CPU. The device 710 includes the graphics processing unit (GPU) and its associated memory 720, referred to herein as device memory. The device memory 720 may include various types of memory, each optimized for different memory usages. For example, in some embodiments, the device memory includes global memory, constant memory, and texture memory.

Parallel portions of a deep learning application may be executed on the architecture 700 as “device kernels” or simply “kernels.” A kernel comprises parameterized code configured to perform a particular function. The parallel computing platform is configured to execute these kernels in an optimal manner across the architecture 700 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by a grid of thread blocks (described in greater detail below). Using concurrent kernel execution, streams, and synchronization with lightweight events, the architecture 700 of FIG. 5 (or similar architectures) may be used to parallelize various operations associated with executing the physics solver, sensitivity computation, and/or optimizer operations described herein. For example, in some embodiments, the mesh describing the design domain is divided into a plurality of sections and multiple versions of the physics solver are applied to the sections in parallel.

The device 710 includes one or more thread blocks 730 which represent the computation unit of the device 710. The term thread block refers to a group of threads that can cooperate via shared memory and synchronize their execution to coordinate memory accesses. For example, in FIG. 5, threads 740, 745 and 750 operate in thread block 730 and access shared memory 735. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 5, the thread blocks 730 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints. In some embodiments, processing of different regions of the mesh may be partitioned over thread blocks automatically by the parallel computing platform software.

Continuing with reference to FIG. 5, registers 755, 760, and 765 represent the fast memory available to thread block 730. Each register is only accessible by a single thread. Thus, for example, register 755 may only be accessed by thread 740. Conversely, shared memory is allocated per thread block, so all threads in the block have access to the same shared memory. Thus, shared memory 735 is designed to be accessed, in parallel, by each thread 740, 745, and 750 in thread block 730. Threads can access data in shared memory 735 loaded from device memory 720 by other threads within the same thread block (e.g., thread block 730). The device memory 720 is accessed by all blocks of the grid and may be implemented by using, for example, Dynamic Random-Access Memory (DRAM).

Each thread can have one or more levels of memory access. For example, in the architecture 700 of FIG. 5, each thread may have three levels of memory access. First, each thread 740, 745, 750, can read and write to its corresponding registers 755, 760, and 765. Registers provide the fastest memory access to threads because there are no synchronization issues and the register is generally located close to a multiprocessor executing the thread. Second, each thread 740, 745, 750 in thread block 730, may read and write data to the shared memory 735 corresponding to that block 730. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 710 to read and/or write to the device memory. Device memory requires the longest time to access because access must be synchronized across the thread blocks operating on the device. Thus, in some embodiments, the processing of each module is coded such that it primarily utilizes registers and shared memory and only utilizes device memory as necessary to move data in and out of a thread block.

The embodiments of the present disclosure may be implemented with any combination of hardware and software. For example, aside from parallel processing architecture presented in FIG. 5, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program codes for providing and facilitating the mechanisms of the embodiments of the present disclosure. The article of manufacture can be included as part of a computer system or sold separately.

Unless stated otherwise as apparent from the following discussion, it will be appreciated that terms such as “applying,” “generating,” “identifying,” “determining,” “processing,” “computing,” “selecting,” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A “graphical user interface” (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

1. A system for topology optimization of a design for manufacturing, comprising:
a processor; and
a memory having modules stored thereon with instructions executable by the processor, the modules comprising:
two or more physics solvers each configured to generate one or more physical field variables and one or more objective values based on received design variables;
two or more sensitivity computational modules each configured to compute a sensitivity field based on the mesh and the physical field variables;
a design optimizer module configured to generate an updated design comprising one or more new design variables by concurrently executing an optimization of the design domain based sensitivity fields of each of the sensitivity computational modules, the objective values, one or more optimization requirements, one or more design constraints, and one or more manufacturing constraints;
wherein an iterative topology optimization is performed by iterations of the design optimizer receiving new sensitivity fields from the two or more sensitivity modules based on the computed physical field variables.

2. The system of claim 1, wherein the design optimizer is further configured to filter the design variables using a convolutional filter yielding an intermediate design variable vector based on neighboring elements with centroids within a radius to a centroid of a current element.

3. The system of claim 2, wherein the design optimizer is further configured to apply a Heaviside projection onto the intermediate design variable vector yielding a geometry vector.

4. The system of claim 3, wherein the design optimizer is further configured to account for design and manufacturing constraints.

5. The system of claim 1, wherein the design optimizer is further configured to map a design computational grid to respective computational grids used by each of the two or more physics solvers and sensitivity computational modules.

6. A computer-implemented method for topology optimization of a design for manufacturing, comprising:
generating one or more physical field variables and one or more objective values based on received design variables, wherein the design is represented as a mesh;
computing a sensitivity field based on the mesh and the physical field variables; and
generating an updated design comprising one or more new design variables by concurrently executing an optimization of the design domain based sensitivity fields of each of the sensitivity computational modules, the objective values, one or more optimization requirements, one or more design constraints, and one or more manufacturing constraints;
wherein an iterative topology optimization is performed by iterations of the design optimizer sending updated design variables to the two or more physics solvers and sensitivity computational modules and receiving new sensitivity fields from the two or more sensitivity modules based on the updated design variables.

7. The method of claim 6, further comprising:
filtering the design variables using a convolutional filter yielding an intermediate design variable vector based on neighboring elements with centroids within a radius to a centroid of a current element.

8. The method of claim 7, further comprising:
applying a Heaviside projection onto the intermediate design variable vector yielding a geometry vector.

9. The method of claim 8, further comprising:
computing a volume of the design and to evaluate manufacturing constraints.

10. The method of claim 6, further comprising:
mapping a design computational grid to respective computational grids used by each of the two or more sensitivity computational modules.
